(19) United States
(12) Patent Application Publication
(10) Pub. No.: US 2024/0322229 A1
(43) Pub. Date: Sep. 26, 2024

(54) BATTERY

(71) Applicant: Panasonic Intellectual Property Management Co., Ltd., Osaka (JP)

(72) Inventor: Takuji TSUJITA, Osaka (JP)

(21) Appl. No.: 18/732,497

(22) Filed: Jun. 3, 2024

Related U.S. Application Data
(63) Continuation of application No. PCT/JP2022/043537, filed on Nov. 25, 2022.

(30) Foreign Application Priority Data
Dec. 7, 2021 (JP) 2021-198903

(51) Int. Cl. H01M 10/0562; H01M 4/505; H01M 4/525; H01M 4/58; H01M 4/62

(52) U.S. Cl. CPC H01M 10/0562; H01M 4/505; H01M 4/525; H01M 4/5825; H01M 4/622; H01M 2300/008

(57) ABSTRACT

A battery of the present disclosure includes a positive electrode layer, a negative electrode layer, and a solid electrolyte layer disposed between the positive electrode layer and the negative electrode layer. The positive electrode layer includes a positive electrode active material and a first solid electrolyte material. The negative electrode layer includes a negative electrode active material and a second solid electrolyte material. The positive electrode active material includes a compound, and the compound includes a transition metal element and an oxoanion and is capable of an electrochemical two-phase coexistence reaction with lithium. The first solid electrolyte material includes Li, M1, and X1, M1 is at least one selected from the group consisting of metalloid elements and metal elements other than Li, and X1 is at least one selected from the group consisting of F, Cl, Br, and I.

This application is a continuation of PCT/JP2022/043537 filed on Nov. 25, 2022, which claims foreign priority of Japanese Patent Application No. 2021-198903 filed on Dec. 7, 2021, the entire contents of both of which are incorporated herein by reference.

### BACKGROUND OF THE INVENTION

### 1. Field of the Invention

The present disclosure relates to a battery.

### 2. Description of Related Art

WO 2019/146308 A1 discloses a battery including an electrode material in which a halide solid electrolyte, an electrode active material, and a coating material positioned on the surface of the electrode active material are included.

### SUMMARY OF THE INVENTION

The present disclosure provides a battery in which a halide solid electrolyte is used to reduce the generation of flammable gases for enhanced safety and also excellent thermal resistance and a large plateau are achieved.

A battery of the present disclosure includes:
a positive electrode layer;
a negative electrode layer; and
a solid electrolyte layer disposed between the positive electrode layer and the negative electrode layer, wherein
the positive electrode layer includes a positive electrode active material and a first solid electrolyte material,
the negative electrode layer includes a negative electrode active material and a second solid electrolyte material,
the positive electrode active material includes a compound, the compound including a transition metal element and an oxoanion and being capable of an electrochemical two-phase coexistence reaction with lithium,
the first solid electrolyte material includes Li, M1, and X1,
the M1 is at least one selected from the group consisting of metalloid elements and metal elements other than Li, and
the X1 is at least one selected from the group consisting of F, Cl, Br, and I.

The present disclosure provides a battery in which a halide solid electrolyte is used to reduce the generation of flammable gases for enhanced safety and also excellent thermal resistance and a large plateau are achieved.

### BRIEF DESCRIPTION OF THE DRAWINGS

FIG. 1 is a cross-sectional view of a battery 1000 according to an embodiment of the present disclosure.

FIG. 2 is a schematic diagram of a pressure-molding die 300 for use in evaluating the ionic conductivity of solid electrolyte materials.

FIG. 3 is a graph showing the charge and discharge characteristics of a battery according to Example 1.

FIG. 4 is a graph showing the initial charge and discharge characteristics of a battery according to Example 2.

FIG. 5 is a graph showing the discharge characteristics of the battery according to Example 2 after being held in a fully charged state for 100 hours in a 125° C. atmosphere.

### DETAILED DESCRIPTION

### Outline of One Aspect According to the Present Disclosure

A battery according to a first aspect of the present disclosure includes:
a positive electrode layer;
a negative electrode layer; and
a solid electrolyte layer disposed between the positive electrode layer and the negative electrode layer, wherein
the positive electrode layer includes a positive electrode active material and a first solid electrolyte material,
the negative electrode layer includes a negative electrode active material and a second solid electrolyte material,
the positive electrode active material includes a compound, the compound including a transition metal element and an oxoanion and being capable of an electrochemical two-phase coexistence reaction with lithium,
the first solid electrolyte material includes Li, M1, and X1,
the M1 is at least one selected from the group consisting of metalloid elements and metal elements other than Li, and
the X1 is at least one selected from the group consisting of F, Cl, Br, and I.

The battery according to the first aspect includes the positive electrode layer including the first solid electrolyte material including Li, M1, and X1, that is, a halide solid electrolyte. A halide solid electrolyte is a highly safe material that does not generate hydrogen sulfide or other flammable gases, unlike a sulfide solid electrolyte and the like. Consequently, in the battery according to the first aspect using a halide solid electrolyte, the generation of flammable gases is reduced to enhance safety. Moreover, in the battery according to the first aspect, the positive electrode active material includes a compound, and the compound includes a transition metal element and an oxoanion and is capable of an electrochemical two-phase coexistence reaction with lithium (Li). Using such a compound as the positive electrode active material in combination with a halide solid electrolyte suppresses oxidative decomposition of the halide solid electrolyte, thereby enhancing the thermal resistance of the battery. Furthermore, using such a compound as the positive electrode active material can achieve a battery having a large plateau with excellent flatness of the potential. As described above, in the battery according to the first aspect with the above configuration, it is possible to reduce the generation of flammable gases for enhanced safety, enhance thermal resistance, and achieve a large plateau.

In a second aspect, for example, the battery according to the first aspect may be such that the positive electrode active material includes the compound as a main component.

The battery according to the second aspect can achieve a larger plateau.

In a third aspect, for example, the battery according to the first or second aspect may be such that the oxoanion includes B, Si, P, or S.

The battery according to the third aspect can achieve a larger plateau.

In a fourth aspect, for example, the battery according to the third aspect may be such that the oxoanion is BO₃_{³}—, SiO₄_{⁴}—, PO₄_{³}—, P₂O₇_{⁴}—, or SO₄_{²}—.

The battery according to the fourth aspect can achieve a larger plateau.

In a fifth aspect, for example, the battery according to any one of the first to fourth aspects may be such that the compound has an olivine structure.

The battery according to the fifth aspect can achieve a larger plateau.

In a sixth aspect, for example, the battery according to any one of the first to fifth aspects may be such that the transition metal element is at least one selected from the group consisting of Fe, Mn, Co, and Ni.

The battery according to the sixth aspect can achieve a larger plateau.

In a seventh aspect, for example, the battery according to any one of the first to sixth aspects may be such that the positive electrode active material includes LiFePO₄.

The battery according to the seventh aspect can achieve a larger plateau.

In an eighth aspect, for example, the battery according to any one of the first to seventh aspects may be such that the M1 includes at least one selected from the group consisting of Na, K, Mg, Ca, Sr, Ba, Sc, Y, Zr, Hf, La, Ce, Pr, Nd, Sm, Eu, Gd, Tb, Dy, Ho, Er, Tm, Yb, and Lu.

In the battery according to the eighth aspect, the ionic conductivity of the positive electrode layer can be further enhanced.

In a ninth aspect, for example, the battery according to the eighth aspect may be such that the M1 includes Y.

In the battery according to the ninth aspect, the ionic conductivity of the positive electrode layer can be further enhanced.

In a tenth aspect, for example, the battery according to the ninth aspect may be such that the first solid electrolyte material includes at least one selected from the group consisting of Li₃₋₃ₐY₁₊ₐBr₂Cl₄ and Li₃₋₃ₐY₁₊ₐCl₆, where a satisfies −0.2≤a≤0.2.

In the battery according to the tenth aspect, the ionic conductivity of the positive electrode layer can be further enhanced.

In an eleventh aspect, for example, the battery according to any one of the first to tenth aspects may be such that the negative electrode active material includes Li₄Ti₅O₁₂.

The battery according to the eleventh aspect can achieve a larger plateau.

In a twelfth aspect, for example, the battery according to any one of the first to eleventh aspects may be such that the second solid electrolyte material includes Li, M2, and X2, the M2 is at least one selected from the group consisting of metalloid elements and metal elements other than Li, and the X2 is at least one selected from the group consisting of F, Cl, Br, and I.

The battery according to the twelfth aspect can achieve further enhanced safety.

### Embodiment of the Present Disclosure

An embodiment of the present disclosure will be described below with reference to the drawings. The present disclosure is not limited to the following embodiment.

A battery according to the embodiment of the present disclosure includes a positive electrode layer, a negative electrode layer, and a solid electrolyte layer disposed between the positive electrode layer and the negative electrode layer. The positive electrode layer includes a positive electrode active material and a first solid electrolyte material. The negative electrode layer includes a negative electrode active material and a second solid electrolyte material. The positive electrode active material includes a compound, and the compound includes a transition metal element and an oxoanion and is capable of an electrochemical two-phase coexistence reaction with lithium. The first solid electrolyte material includes Li, M1, and X1. Here, M1 is at least one selected from the group consisting of metalloid elements and metal elements other than Li, and X1 is at least one selected from the group consisting of F, Cl, Br, and I.

As used herein, the “metalloid elements” refer to B, Si, Ge, As, Sb, and Te. Moreover, the “metal elements” refer to all the elements included in Groups 1 to 12 of the periodic table except hydrogen and all the elements included in Groups 13 to 16 of the periodic table except B, Si, Ge, As, Sb, Te, C, N, P, O, S, and Se. That is, the “metalloid elements” and the “metal elements” are each a group of elements that can become a cation when forming an inorganic compound with a halogen element.

The battery according to the present embodiment includes the positive electrode layer including the first solid electrolyte material including Li, M1, and X1, that is, a halide solid electrolyte. A halide solid electrolyte is a highly safe material that does not generate hydrogen sulfide or other flammable gases, unlike a sulfide solid electrolyte and the like. Consequently, in the battery according to the present embodiment using a halide solid electrolyte, the generation of flammable gases is reduced to enhance safety.

As described above, using a halide solid electrolyte can enhance the safety of the battery. However, a halide solid electrolyte may undergo oxidative decomposition due to contact with the positive electrode active material. To address such a problem, in the battery according to the present embodiment, the positive electrode active material includes a compound, and the compound includes a transition metal element and an oxoanion and is capable of an electrochemical two-phase coexistence reaction with lithium (Li). Using such a compound as the positive electrode active material in combination with a halide solid electrolyte suppresses oxidative decomposition of the halide solid electrolyte, and therefore can achieve a battery having excellent thermal resistance. Furthermore, using such a compound as the positive electrode active material can achieve a battery having a large plateau with excellent flatness of the potential.

As described above, in the battery according to the present embodiment with the above configuration, it is possible to reduce the generation of flammable gases for enhanced safety, enhance thermal resistance, and achieve a large plateau.

It is conventionally known that a compound capable of an electrochemical two-phase coexistence reaction with lithium can be used as the positive electrode active material of a lithium secondary battery.

For example, lithium iron phosphate LiFePO₄ having an olivine structure is known to, during charge and discharge by Li ion deintercalation and intercalation, undergo a two-phase coexistence reaction between two phases LiFePO₄ and FePO₄ (A. K. Padhi, K. S. Nanjundaswamy, and J. B. Goodenough, “Phospho-olivines as Positive-Electrode Materials for Rechargeable Lithium Batteries”, J. Electrochem. Soc., 144, 1188 (1997)).

Moreover, lithium iron borate LiFeBO₃ is known to, during charge and discharge by Li ion deintercalation and intercalation, undergo a two-phase coexistence reaction between two phases LiFeBO₃ and Li_{0.5}FeBO₃ (Shou-Hang Bo, Kyung-Wan Nam, Olaf J. Borkiewicz, Yan-Yan Hu, Xiao-Qing Yang, Peter J. Chupas, Karena W. Chapman, Lijun Wu, Lihua Zhang, Feng Wang, Clare P. Grey, and Peter G. Khalifah, “Structures of Delithiated and Degraded LiFeBO₃, and Their Distinct Changes upon Electrochemical Cycling”, Inorg. Chem. 53, 13, 6585-6595 (2014)).

Furthermore, lithium iron sulfate Li₂Fe(SO₄)₂ is known to, during charge and discharge by Li ion deintercalation and intercalation: for monoclinic Li₂Fe(SO₄)₂, undergo a two-phase coexistence reaction between two phases Li₂Fe(SO₄)₂ and LiFe(SO₄)₂; and for orthorhombic Li₂Fe(SO₄)₂, successively undergo a two-phase coexistence reaction between two phases Li₂Fe(SO₄)₂ and Li_{1.5}Fe(SO₄)₂ and a two-phase coexistence reaction between two phases Li_{1.5}Fe(SO₄)₂ and LiFe(SO₄)₂ (Laura Lander, Marine Reynaud, Javier Carrasco, Nebil A Katcho, Christophe Bellin, Alain Polian, Benoit Baptiste, Gwenaelle Rousse, Jean-Marie Tarascon, “Unveiling the electrochemical mechanisms of Li₂Fe(SO₄)₂ polymorphs by neutron diffraction and density functional theory calculations”, Phys. Chem. Chem. Phys., 18 (21), 14509-19 (2016)).

In addition, lithium manganese silicate Li₂MnSiO₄ is known to, during charge and discharge by Li ion deintercalation and intercalation, undergo a two-phase coexistence reaction between two phases Li₂MnSiO₄ and LiMnSiO₄ (R. Dominko, M. Bele, A. Kokalj, M. Gaberscek, J. Jamnik, “Li₂MnSiO₄ as a potential Li-battery cathode material”, Journal of Power Sources. Volume 174, Issue 2, Pages 457-461).

Thus, the battery according to the present embodiment can use, as the compound including a transition metal element and an oxoanion and being capable of an electrochemical two-phase coexistence reaction with lithium, any of known compounds conventionally proposed such as those described above.

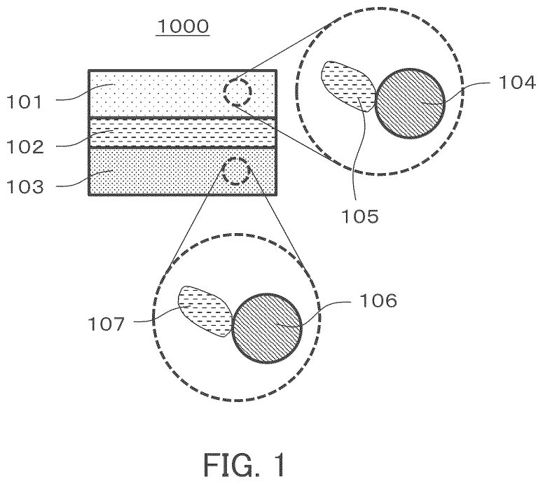

FIG. 1 is a cross-sectional view of a battery 1000 according to the embodiment of the present disclosure.

The battery 1000 according to the present embodiment includes a positive electrode layer 101, a negative electrode layer 103, and a solid electrolyte layer 102 disposed between the positive electrode layer 101 and the negative electrode layer 103.

The positive electrode layer 101 includes a positive electrode active material 104 and a first solid electrolyte material 105. The positive electrode active material 104 includes a compound, and the compound includes a transition metal element and an oxoanion and is capable of an electrochemical two-phase coexistence reaction with lithium. The first solid electrolyte material 105 includes Li, M1, and X1. M1 and X1 are as described above.

The negative electrode layer 103 includes a negative electrode active material 106 and a second solid electrolyte material 107.

The battery 1000 may be an all-solid-state battery.

The constituent elements of the battery 1000 according to the present embodiment will be described in more detail below.

### (Positive Electrode Layer 101)

The positive electrode layer 101 includes a material having properties of occluding and releasing metal ions (e.g., lithium ions). The positive electrode layer 101 includes the positive electrode active material 104 and the first solid electrolyte material 105.

A volume ratio Vp of the volume of the positive electrode active material 104 to the sum of the volumes of the positive electrode active material 104 and the first solid electrolyte material 105 in the positive electrode layer 101 may be 0.3 or more and 0.95 or less. In the case where the volume ratio Vp is 0.3 or more, the battery 1000 easily achieves a sufficient energy density. In the case where the volume ratio Vp is 0.95 or less, the battery 1000 more easily operates at a high output.

The positive electrode layer 101 may have a thickness of 10 μm or more and 500 μm or less.

In the case where the positive electrode layer 101 has a thickness of 10 μm or more, the battery 1000 can achieve a sufficient energy density. Moreover, in the case where the positive electrode layer 101 has a thickness of 500 μm or less, the battery 1000 can operate at a high output.

The positive electrode layer 101 may include a binder. The binder is used in order to enhance the binding properties of the materials for the positive electrode layer 101. Examples of the binder include polyvinylidene fluoride, polytetrafluoroethylene, polyethylene, polypropylene, an aramid resin, a polyamide, a polyimide, a polyamide-imide, polyacrylonitrile, a polyacrylic acid, polyacrylic acid methyl ester, polyacrylic acid ethyl ester, polyacrylic acid hexyl ester, a polymethacrylic acid, polymethacrylic acid methyl ester, polymethacrylic acid ethyl ester, polymethacrylic acid hexyl ester, polyvinyl acetate, polyvinylpyrrolidone, a polyether, a polyethersulfone, hexafluoropolypropylene, styrene-butadiene rubber, and carboxymethyl cellulose. Moreover, the binder can be a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. The binder may be a mixture of two or more selected from the above.

The positive electrode layer 101 may include a conductive material. The conductive material is used in order to enhance the electronic conductivity. The conductive material can be, for example, graphite, such as natural graphite or artificial graphite, carbon black, such as acetylene black or Ketjenblack, a conductive fiber, such as a carbon fiber or a metal fiber, fluorinated carbon, a metal powder, such as an aluminum powder, a conductive whisker, such as a zinc oxide whisker or a potassium titanate whisker, a conductive metal oxide, such as titanium oxide, or a conductive polymer compound, such as a polyaniline compound, a polypyrrole compound, or a polythiophene compound. In the case where a conductive carbon material is used, cost reduction can be achieved. The above conductive materials may be used alone or in combination.

The positive electrode layer 101 may further include a positive electrode current collector.

The positive electrode current collector can be, for example, a metal foil. Examples of the metal constituting the positive electrode current collector include aluminum, titanium, an alloy including any of these metal elements, and stainless steel. The thickness of the positive electrode current collector is not particularly limited and is, for example, 3 μm or more and 50 μm or less. The metal foil may be coated with carbon or the like.

### Positive Electrode Active Material 104

As described above, the positive electrode active material 104 of the battery 1000 according to the present embodiment includes a compound, and the compound includes a transition metal element and an oxoanion and is capable of an electrochemical two-phase coexistence reaction with lithium. The positive electrode active material 104 may include the above compound as the main component. The “main component” as used herein refers to a component having the highest mass content.

In the above compound, the oxoanion may include B, Si, P, or S. In the case where such a compound is used as the positive electrode active material 104, a larger plateau can be achieved.

In the above compound, the oxoanion may be BO₃_{³⁻}, SiO₄_{⁴⁻}, PO₄_{³⁻}, P₂O₇_{⁴⁻}, or SO₄_{²⁻}. In the case where such a compound is used as the positive electrode active material 104, a larger plateau can be achieved.

In the above compound, the transition metal element may be at least one selected from the group consisting of Fe, Mn, Co, and Ni. In the case where such a compound is used as the positive electrode active material 104, a larger plateau can be achieved.

In the above compound, the transition metal element may be at least one selected from the group consisting of Fe and Mn. The transition metal element may include Fe and may be Fe. In the case where such a compound is used as the positive electrode active material 104, a larger plateau can be achieved.

The above compound may have an olivine structure. In the case where such a compound is used as the positive electrode active material 104, a larger plateau can be achieved.

The above compound may be at least one selected from the group consisting of LiFePO₄, LiFeBO₃, Li₂Fe(SO₄)₂, and Li₂MnSiO₄. In the case where such a compound is used as the positive electrode active material 104, a larger plateau can be achieved.

The positive electrode active material 104 may include LiFePO₄. In the case where the positive electrode active material 104 includes LiFePO₄, a larger plateau can be achieved.

The positive electrode active material 104 may have a median diameter of 0.05 μm or more and 100 μm or less.

In the case where the positive electrode active material 104 has a median diameter of 0.05 μm or more, the positive electrode active material 104 and the first solid electrolyte material 105 can form a favorable dispersion state. This enhances the charge and discharge characteristics of the battery 1000. Moreover, in the case where the positive electrode active material 104 has a median diameter of 100 μm or less, lithium diffuses at an enhanced rate in the positive electrode active material 104. This enables the battery 1000 to operate at a high output.

The positive electrode active material 104 may have a larger median diameter than the first solid electrolyte material 105 has. With this configuration, the positive electrode active material 104 and the first solid electrolyte material 105 can form a favorable dispersion state.

The median diameter as used herein means the particle diameter at a cumulative volume equal to 50% (volume average particle diameter) in the volumetric particle size distribution measured by a laser diffraction scattering method.

On the surface of the positive electrode active material 104, a coating layer having an approximate thickness of 1 nm to 100 nm may be provided. In the case where the coating layer is provided on the surface of the positive electrode active material 104, the thermal resistance and oxidation resistance can be further enhanced. Possible examples of the coating layer include an oxide such as Al₂Oₓ (x satisfies, for example, 0<x<3) or BaTiO₃ and a solid electrolyte such as lithium phosphate.

The method for forming the coating layer is not limited and can be, for example, any of the following methods. The coating layer may be formed on the surface of the positive electrode active material 104 by a vapor phase method, such as sputtering or electron-beam vapor deposition. The coating layer can also be formed by forming a metal layer on the surface of the positive electrode active material 104 by a vapor phase method, plating, or the like, followed by heating in an oxygen atmosphere. For example, after a mixture layer including the positive electrode active material 104 and the first solid electrolyte material 105 is formed on the positive electrode current collector, the coating layer may be formed on the surface of the positive electrode active material 104 by a liquid phase method, such as spray coating or dip coating.

### (First Solid Electrolyte Material 105)

The first solid electrolyte material 105 includes Li, M1, and X1, that is, includes a halide solid electrolyte. The first solid electrolyte material 105 may consist substantially of Li, M1, and X1. The phrase “the first solid electrolyte material 105 consists substantially of Li, M1, and X1” means that the ratio of the sum of the amounts of substance of Li, M1, and X1 to the total of the amounts of substance of all the elements constituting the first solid electrolyte material 105 in the first solid electrolyte material 105 (i.e., mole fraction) is 90% or more. In an example, the ratio (i.e., mole fraction) may be 95% or more. The first solid electrolyte material 105 may consist of Li, M1, and X1. The first solid electrolyte material 105 may be substantially free of sulfur. The phrase “the first solid electrolyte material 105 is substantially free of sulfur” means that the first solid electrolyte material 105 does not contain sulfur as the constituent element, except for sulfur unavoidably incorporated as an impurity. In this case, the content of sulfur incorporated as an impurity in the first solid electrolyte material 105 is, for example, 1 mol % or less. The first solid electrolyte material 105 may be free of sulfur. The solid electrolyte material free of sulfur does not generate hydrogen sulfide when exposed to the atmosphere, and thus is excellent in safety.

To enhance the ionic conductivity, M1 may include at least one element selected from the group consisting of a Group 1 element, a Group 2 element, a Group 3 element, a Group 4 element, and a lanthanoid element.

Moreover, M1 may include a Group 5 element, a Group 12 element, a Group 13 element, and a Group 14 element.

Examples of the Group 1 element include Na, K, Rb, and Cs. Examples of the Group 2 element include Mg, Ca, Sr, and Ba. Examples of the Group 3 element include Sc and Y. Examples of the Group 4 element include Ti, Zr, or Hf. Examples of the lanthanoid element include La, Ce, Pr, Nd, Sm, Eu, Gd, Tb, Dy, Ho, Er, Tm, Yb, and Lu.

Examples of the Group 5 element include Nb and Ta. Examples of the Group 12 element include Zn. Examples of the Group 13 element include Al, Ga, and In. Examples of the Group 14 element include Sn.

To further enhance the ionic conductivity, M1 may include at least one element selected from the group consisting of Na, K, Mg, Ca, Sr, Ba, Sc, Y, Zr, Hf, La, Ce, Pr, Nd, Sm, Eu, Gd, Tb, Dy, Ho, Er, Tm, Yb, and Lu.

To further enhance the ionic conductivity, M1 may include at least one element selected from the group consisting of Mg, Ca, Sr, Y, Sm, Gd, Dy, and Hf, and may include Y.

As described above, X1 is at least one selected from the group consisting of F, Br, Cl, and I.

To further enhance the ionic conductivity, X1 may include Br, Cl, and I.

The first solid electrolyte material 105 may be Li₃₋₃ₐY₁₊ₐX₆, where a satisfies, for example, −0.2≤a≤0.2. The first solid electrolyte material 105 may be Li₃₋₃ₐY₁₊ₐBr₆, and may be Li₃₋₃ₐY₁₊ₐCl₆. The first solid electrolyte material 105 may be Li₃₋₃ₐY₁₊ₐBrₓ₁Cl₆₋ₓ₁ (0≤x1<6). The first solid electrolyte material 105 may be Li₃₋₃ₐY₁₊ₐBrₓ₂Cl_{y2}I_{6-x2-y2} (0≤x2, 0≤y2, and 0≤x2+y2≤6).

To further enhance the ionic conductivity, the first solid electrolyte material 105 may include at least one selected from the group consisting of Li₃₋₃ₐY₁₊ₐBr₆, Li₃₋₃ₐY₁₊ₐBrₓ₁Cl₆₋ₓ₁, Li₃₋₃ₐY₁₊ₐCl₆, and Li₃₋₃ₐY₁₊ₐBrₓ₂Cl_{y2}I_{6-x2-y2}.

In the above composition formula, x1=2 may be satisfied. Moreover, in the above composition formula, x2=2 and y2=2 may be satisfied.

To further enhance the ionic conductivity, the first solid electrolyte material 105 may include at least one selected from the group consisting of Li₃₋₃ₐY₁₊ₐBr₆, Li₃₋₃ₐY₁₊ₐBr₂Cl₄, Li₃₋₃ₐY₁₊ₐCl₆, and Li₃₋₃ₐY₁₊ₐBr₂Cl₂I₂.

To further enhance the ionic conductivity, the first solid electrolyte material 105 may include at least one selected from the group consisting of Li₃₋₃ₐY₁₊ₐBr₂Cl₄ and Li₃₋₃ₐY₁₊ₐCl₆.

In the above composition formula, a=0 may be satisfied.

The first solid electrolyte material 105 may further include a polymer solid electrolyte.

The polymer solid electrolyte can be, for example, a compound of a polymer compound and a lithium salt. The polymer compound may have an ethylene oxide structure. The polymer solid electrolyte having an ethylene oxide structure can contain a lithium salt in a large amount, thereby further enhancing the ionic conductivity. The lithium salt can be LiPF₆, LiBF₄, LiSbF₆, LiAsF₆, LiSO₃CF₃, LiN(SO₂CF₃)₂, LIN(SO₂C₂F₅)₂, LiN(SO₂CF₃)(SO₂C₄F₉), LiC(SO₂CF₃)₃, or the like. One lithium salt selected from the above can be used alone as the lithium salt. Alternatively, a mixture of two or more lithium salts selected from the above can be used as the lithium salt.

The first solid electrolyte material 105 may further include a complex hydride solid electrolyte.

The complex hydride solid electrolyte can be, for example, LiBH₄—LiI or LiBH₄—P₂S₅.

The shape of the first solid electrolyte material 105 is not particularly limited and may be, for example, an acicular shape, a spherical shape, or an ellipsoidal shape. The first solid electrolyte material 105 may be, for example, particulate.

For example, in the case where the first solid electrolyte material 105 is particulate (e.g., spherical), the first solid electrolyte material 105 may have a median diameter of 100 μm or less. In the case where the first solid electrolyte material 105 has a median diameter of 100 μm or less, the positive electrode active material 104 and the first solid electrolyte material 105 can form a favorable dispersion state. This enhances the charge and discharge characteristics of the battery 1000.

The first solid electrolyte material 105 may have a median diameter of 10 μm or less. With this configuration, the positive electrode active material 104 and the first solid electrolyte material 105 can form a more favorable dispersion state.

The first solid electrolyte material 105 may have a smaller median diameter than the positive electrode active material 104 has. With this configuration, the positive electrode active material 104 and the first solid electrolyte material 105 can form a more favorable dispersion state.

### (Negative Electrode Layer 103)

The negative electrode layer 103 includes a material having properties of occluding and releasing metal ions (e.g., lithium ions). The negative electrode layer 103 includes the negative electrode active material 106 and the second solid electrolyte material 107.

In the negative electrode layer 103, the content of the second solid electrolyte material 107 and the content of the negative electrode active material 106 may be equal to or different from each other.

A volume ratio Vn of the volume of the negative electrode active material 106 to the sum of the volumes of the negative electrode active material 106 and the second solid electrolyte material 107 in the negative electrode layer 103 may be 0.3 or more and 0.95 or less. In the case where the volume ratio Vn is 0.3 or more, the battery 1000 easily achieves a sufficient energy density. In the case where the volume ratio Vn is 0.95 or less, the battery 1000 more easily operates at a high output.

The negative electrode layer 103 may have a thickness of 10 μm or more and 500 μm or less.

In the case where the negative electrode layer 103 has a thickness of 10 μm or more, the battery 1000 can achieve a sufficient energy density. Moreover, in the case where the negative electrode 203 has a thickness of 500 μm or less, the battery 1000 can operate at a high output.

The negative electrode layer 103 may further include a negative electrode current collector. The material for the negative electrode current collector can be the same as the material usable for the positive electrode current collector. The thickness of the negative electrode current collector is not particularly limited and is, for example, 3 μm to 50 μm. In addition, in the case where a lithium alloy or a lithium-occluding metal is used as the negative electrode active material 106, the lithium-occluding alloy can also be used as the negative electrode active material and as the negative electrode current collector at the same time.

The negative electrode layer 103 may include a negative electrode current collector and a negative electrode mixture layer supported on the surface of the negative electrode current collector. The negative electrode mixture layer can be formed by, for example: applying, to the surface of the negative electrode current collector, a negative electrode slurry in which a negative electrode mixture obtained by mixing the negative electrode active material 106 and the second solid electrolyte material 107 is dispersed in a dispersion medium; and drying the negative electrode slurry. The coating film obtained after drying may be rolled as necessary. The negative electrode mixture layer may be formed on one surface or both surfaces of the negative electrode current collector.

The negative electrode mixture can further include a binder, a conductive material, a thickener, and the like. The binder and the conductive material can be the same as those for the positive electrode layer 101.

### (Negative Electrode Active Material 106)

The negative electrode active material 106 may include a carbon material capable of occluding and releasing lithium ions. Examples of the carbon material capable of occluding and releasing lithium ions include graphite (natural graphite and artificial graphite), graphitizable carbon (soft carbon), and non-graphitizable carbon (hard carbon). Desirable among these is graphite, which is excellent in stability during charge and discharge and also has a low irreversible capacity.

The negative electrode active material 106 may include an alloy-based material. The alloy-based material refers to a material including at least one metal capable of forming an alloy with lithium, and is, for example, silicon, tin, indium, a silicon alloy, a tin alloy, an indium alloy, or a silicon compound. The silicon compound may be a composite material including a lithium-ion conductive phase and silicon particles dispersed in the phase. The lithium-ion conductive phase may be a silicate phase such as a lithium silicate phase, a silicon oxide phase in which 95 mass % or more is silicon dioxide, a carbon phase, or the like.

The negative electrode active material 106 may include lithium titanium oxide. The lithium titanium oxide may include at least one material selected from the group consisting of Li₄Ti₅O₁₂, Li₇Ti₅O₁₂, and LiTi₂O₄.

The negative electrode active material 106 may include Li₄Ti₅O₁₂ in order to enhance the thermal resistance and achieve a larger plateau.

The negative electrode active material 106 may be a combination of an alloy-based material and a carbon material or a combination of a lithium titanium oxide and a carbon material.

### (Second Solid Electrolyte Material 107)

The second solid electrolyte material 107 is not particularly limited and may be a halide solid electrolyte similarly to the first solid electrolyte material 105 described above. The second solid electrolyte material may include, for example, Li, M2, and X2. Here, M2 is at least one selected from the group consisting of metalloid elements and metal elements other than Li, and X2 is at least one selected from the group consisting of F, Cl, Br, and I.

The second solid electrolyte material 107 may be a material having the same composition as the composition of the first solid electrolyte material 105, or may be a material having a different composition from the composition of the first solid electrolyte material 105.

In the second solid electrolyte material 107, any of the polymer solid electrolytes described as examples for the first solid electrolyte material 105 may be used, and any of the complex hydride solid electrolytes described as examples for the first solid electrolyte material 105 may be used.

In the second solid electrolyte material 107, a sulfide solid electrolyte may be used, and an oxide solid electrolyte may be used.

The sulfide solid electrolyte can be, for example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or Li₆PS₅Cl. Moreover, LiX (X: any of F, Cl, Br, and I), Li₂O, MOq, LipMOq (M: any of P, Si, Ge, B, Al, Ga, In, Fe, and Zn) (p and q: natural number), and the like may be added to the above.

The oxide solid electrolyte can be, for example: a NASICON solid electrolyte typified by LiTi₂(PO₄)₃ and element-substituted substances thereof; a (LaLi) TiO₃-based perovskite solid electrolyte; a LISICON solid electrolyte typified by Li₁₄ZnGe₄O₁₆, Li₄SiO₄, and LiGeO₄ and element-substituted substances thereof; a garnet solid electrolyte typified by Li₇La₃Zr₂O₁₂ and element-substituted substances thereof; Li₃N and H-substituted substances thereof; Li₃PO₄ and N-substituted substances thereof; or glass or glass ceramics based on a Li—B—O compound, such as LiBO₂ or Li₃BO₃, to which Li₂SO₄, Li₂CO₃, or the like is added.

### (Solid Electrolyte Layer 102)

The solid electrolyte layer 102 is disposed between the positive electrode layer 101 and the negative electrode layer 103.

The solid electrolyte layer 102 is a layer including a solid electrolyte material.

The solid electrolyte material included in the solid electrolyte layer 102 may be any of the materials described as examples for the first solid electrolyte material 105 and for the second solid electrolyte material 107. The solid electrolyte layer 102 may include a solid electrolyte material having the same composition as the composition of the first solid electrolyte material 105, and may include a solid electrolyte material having the same composition as the composition of the second solid electrolyte material 107. The solid electrolyte layer 102 may include a material different from the first solid electrolyte material 105 and from the second solid electrolyte material 107.

The solid electrolyte layer 102 may include two or more of the materials described as examples of the solid electrolyte material. For example, the solid electrolyte layer may include a halide solid electrolyte and a sulfide solid electrolyte.

The solid electrolyte layer 102 may include a first electrolyte layer and a second electrolyte layer. The first electrolyte layer may be positioned between the positive electrode layer 101 and the negative electrode layer 103, and the second electrolyte layer may be positioned between the first electrolyte layer and the negative electrode layer 103. The first electrolyte layer may include a material having the same composition as the composition of the first solid electrolyte material 105. The second electrolyte layer may include a material having a different composition from the composition of the first solid electrolyte material 105. The second electrolyte layer may include a material having the same composition as the composition of the second solid electrolyte material 107.

The solid electrolyte layer 102 may include a binder as appropriate. The binder can be the same as that for the positive electrode layer 101.

The solid electrolyte layer 102 may be formed of any of the materials described as examples for the first solid electrolyte material 105 and for the second solid electrolyte material 107.

The solid electrolyte layer 102 can be formed by, for example, drying a solid electrolyte slurry, in which a solid electrolyte material is dispersed in a dispersion medium, into the form of a sheet and transferring the sheet to the surface of the positive electrode layer 101 or the surface of the negative electrode layer 103. Moreover, the solid electrolyte layer 102 can also be formed by directly applying the solid electrolyte slurry to the surface of the positive electrode layer 101 or the surface of the negative electrode layer 103 and drying the solid electrolyte slurry.

Although the methods for forming the positive electrode layer 101, the negative electrode layer 103, and the solid electrolyte layer 102 by using slurries have been described, the method for manufacturing the battery 1000 is not limited to coating. The battery 1000 according to the present embodiment may be manufactured by, for example, preparing a material for the positive electrode, a material for the electrolyte layer, and a material for the negative electrode, and producing by a known method a stack composed of the positive electrode, the electrolyte layer, and the negative electrode disposed in this order. For example, the battery 1000 can also be formed by forming a positive electrode layer including the positive electrode active material 104, the first solid electrolyte material 105, and the conductive material, a solid electrolyte layer, and a negative electrode layer including the negative electrode active material 106, the second solid electrolyte material 107, and the conductive material by powder compacting and then bonding these layers together.

### EXAMPLES

The present invention will be described in detail below with reference to examples and comparative examples. The present invention is not limited to the following examples.

### Example 1

(Production of First Solid Electrolyte Material and Second Solid Electrolyte Material) In a dry argon atmosphere, raw material powders LiBr, YBr₃, LiCl, and YCl₃ were weighed in a molar ratio of Li:Y:Br:Cl=3:1:2:4. These were pulverized and mixed in a mortar. The resulting mixture was then milled in a planetary ball mill at 600 rpm for 25 hours. Thus, a powder of a halide solid electrolyte material including Li, Y, Br, and Cl, serving as the first solid electrolyte material and the second solid electrolyte material of Example 1, was obtained. The material produced in Example 1 as the first solid electrolyte material and the second solid electrolyte material are hereinafter referred to as a solid electrolyte material produced in Example 1.

### (Evaluation of Composition)

The solid electrolyte material produced in Example 1 was subjected to composition evaluation by inductively coupled plasma (ICP) emission spectrometry. The results indicate that the deviation of Li/Y from the feed composition was 3% or less. That is, the feed composition obtained with the planetary ball mill and the composition of the solid electrolyte material produced in Example 1 are regarded as almost the same.

### (Evaluation of Crystal Structure and Crystallinity)

In a dry atmosphere with a dew point of −40° C. or lower, the powder of the solid electrolyte material produced in Example 1 was subjected to X-ray diffractometry to obtain an X-ray diffraction pattern. In the analysis of the crystal structure, an X-ray diffractometer (MiniFlex 600 manufactured by Rigaku Corporation) was used. The X-ray source used was Cu—Ka radiation. As a result of the evaluation by the X-ray diffraction (XRD) method, an X-ray diffraction pattern belonging to a monoclinic crystal as the main crystalline phase was observed.

The term “monoclinic crystal” as used in the present disclosure means a crystalline phase having a crystal structure similar to the crystal structure of Li₃ErBr₆ disclosed in Inorganic Crystal Structure Database (ICSD) #01-087-0159 and having an X-ray diffraction pattern specific to this crystal structure. Accordingly, the presence of the monoclinic crystal in the solid electrolyte material is determined on the basis of the X-ray diffraction pattern. At this time, the diffraction angle and/or peak intensity ratio of the diffraction pattern can differ from that/those of Li₃ErBr₆ depending on the type of elements included in the solid electrolyte material.

### (Evaluation of Ionic Conductivity)

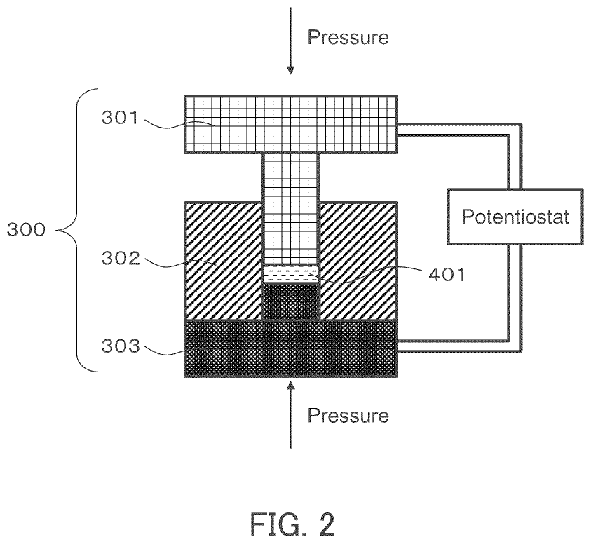

FIG. 2 is a schematic diagram of a pressure-molding die 300 for use in evaluating the ionic conductivity of solid electrolyte materials.

The pressure-molding die 300 included an upper punch 301, a die 302, and a lower punch 303. The upper punch 301 and the lower punch 303 were both made of stainless steel, which is electronically conductive. The die 302 was made of polycarbonate, which is insulating.

The solid electrolyte material produced in Example 1 was subjected to ionic conductivity measurement with the pressure-molding die 300 shown in FIG. 2 by the following method.

In a dry atmosphere with a dew point of −30° C. or lower, the pressure-molding die was filled with the solid electrolyte material produced in Example 1 (namely, a solid electrolyte material powder 401 shown in FIG. 2). Inside the pressure-molding die, a pressure of 300 MPa was applied to the solid electrolyte material produced in Example 1 with the upper punch 301 and the lower punch 303.

While the pressure was applied, the upper punch 301 and the lower punch 303 were connected to a potentiostat (VersaSTAT 4 manufactured by Princeton Applied Research) equipped with a frequency response analyzer. The upper punch 301 was connected to the working electrode and the potential measurement terminal. The lower punch 303 was connected to the counter electrode and the reference electrode. The solid electrolyte material produced in Example 1 was subjected to electrochemical impedance measurement at room temperature to measure the ionic conductivity.

The ionic conductivity of the solid electrolyte material produced in Example 1, measured at 22° C., was 1.5×10⁻³ S/cm. The same solid electrolyte material was also used in Example 2, Example 3, Comparative Example 1, and Comparative Example 2.

### (Production of Positive Electrode Mixture)

The positive electrode active material used was lithium iron phosphate LiFePO₄ (manufactured by Hitachi Zosen Corporation).

In a dry argon atmosphere, the solid electrolyte material produced in Example 1 and the above positive electrode active material were weighed in a volume ratio of 50:50. Vapor-grown carbon fibers (VGCF (manufactured by SHOWA DENKO K.K.)) serving as the conductor were weighed in 5 mass % with respect to the sum of the masses of the solid electrolyte material and the positive electrode active material. These were mixed in an agate mortar to produce a positive electrode mixture. VGCF is a registered trademark of SHOWA DENKO K.K.

### (Production of Negative Electrode Mixture)

The negative electrode active material used was lithium titanate Li₄Ti₅O₁₂ (manufactured by Toshima Manufacturing Co., Ltd.).

In a dry argon atmosphere, the solid electrolyte material produced in Example 1 and the above negative electrode active material were weighed in a volume ratio of 40:60. VGCF serving as the conductor was weighed in 5.7 mass % with respect to the sum of the masses of the solid electrolyte material and the negative electrode active material. These were mixed in an agate mortar to produce a negative electrode mixture.

### (Production of Battery)

In an insulating outer cylinder having an inner diameter of 9.4 mm, 28.3 mg of the positive electrode mixture, 100 mg of the solid electrolyte material produced in Example 1, and 67.4 mg of the negative electrode mixture were stacked in this order. These were pressure-molded at a pressure of 720 MPa to produce a stack composed of a positive electrode layer, an electrolyte layer, and a negative electrode layer. Subsequently, stainless steel current collectors were disposed on the top and the bottom of the stack, and current collector leads were attached to the current collectors. Lastly, an insulating ferrule was used to block the inside of the insulating outer cylinder from the outside air atmosphere to hermetically seal the cylinder to produce the battery according to Example 1.

### (Charge and Discharge Test)

A charge and discharge test was performed on the above battery of Example 1 as follows.

The battery was placed in a thermostatic chamber set at 25° C. Constant-current charge was performed at a current value of 130 μA until the potential reached 3.6 V vs. Li, followed by low-voltage charge at 26 μA to the end of the charge.

Subsequently, discharge was performed at a current value of 130 μA until the potential reached 2.5 V vs. Li to the end of the discharge.

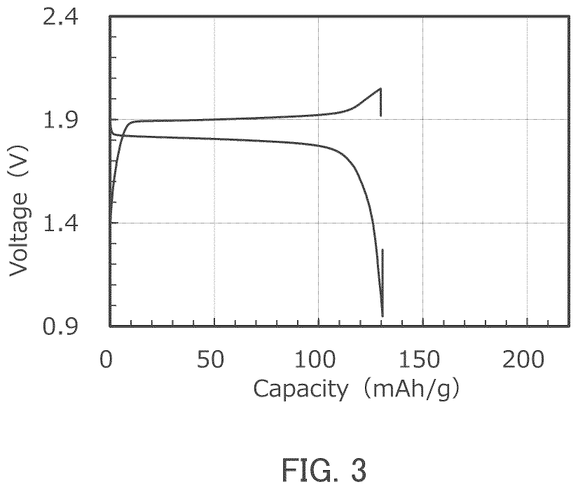

FIG. 3 is a graph showing the charge and discharge characteristics of the battery according to Example 1. This graph demonstrates that Example 1 can achieve a battery having a large plateau.

### Example 2

### (Production of First Solid Electrolyte Material and Second Solid Electrolyte Material)

To produce the first solid electrolyte material, raw material powders LiCl and YCl₃ were weighed in a molar ratio of Li:Y:Cl=3:1:6 in a dry argon atmosphere. These were pulverized and mixed in a mortar. The resulting mixture was then milled in a planetary ball mill at 600 rpm for 25 hours. Thus, a powder of a halide solid electrolyte material including Li, Y, and Cl, serving as the first solid electrolyte material of Example 2, was obtained.

The first solid electrolyte material produced in Example 2 was evaluated in the same manner as in Example 1 for composition ratio, crystal structure, crystallinity, and ionic conductivity. As a result of the evaluation of the composition ratio of the first solid electrolyte material produced in Example 2, the deviation of Li/Y from the feed composition was 3% or less as in Example 1. That is, the feed composition obtained with the planetary ball mill and the composition of the first solid electrolyte material produced in Example 2 are regarded as almost the same. An X-ray diffraction pattern belonging to a monoclinic crystal as the main crystalline phase of the first solid electrolyte material produced in Example 2 was observed. The ionic conductivity of the first solid electrolyte material produced in Example 2 was 3.0×10⁻⁴ S/cm.

In addition, the second solid electrolyte material used was the solid electrolyte material produced in Example 1.

The positive electrode mixture and the negative electrode mixture were produced in the same manner as in Example 1, except that the first solid electrolyte material for use in producing the positive electrode mixture was changed to that produced in Example 2.

### (Production of Battery)

In an insulating outer cylinder, the positive electrode mixture was weighed so that the positive electrode active material would be equal in amount to the positive electrode active material of the positive electrode mixture of Example 1. In an insulating outer cylinder having an inner diameter of 9.4 mm, the positive electrode mixture, 50 mg of the first solid electrolyte material, 50 mg of the second solid electrolyte material, and 67.4 mg of the negative electrode mixture were stacked in this order. These were pressure-molded at a pressure of 720 MPa to produce a stack composed of a positive electrode layer, an electrolyte layer, and a negative electrode layer. Subsequently, stainless steel current collectors were disposed on the top and the bottom of the stack, and current collector leads were attached to the current collectors. Lastly, an insulating ferrule was used to block the inside of the insulating outer cylinder from the outside air atmosphere to hermetically seal the cylinder to produce the battery according to Example 2.

### (Charge and Discharge Test)

A charge and discharge test was performed on the above battery of Example 2 as follows.

The battery was placed in a thermostatic chamber set at 125° C.

Constant-current charge was performed at a current value of 130 μA until the potential reached 3.6 V vs. Li, followed by low-voltage charge at 26 μA to the end of the charge.

Subsequently, discharge was performed at a current value of 130 μA until the potential reached 2.5 V vs. Li to the end of the discharge.

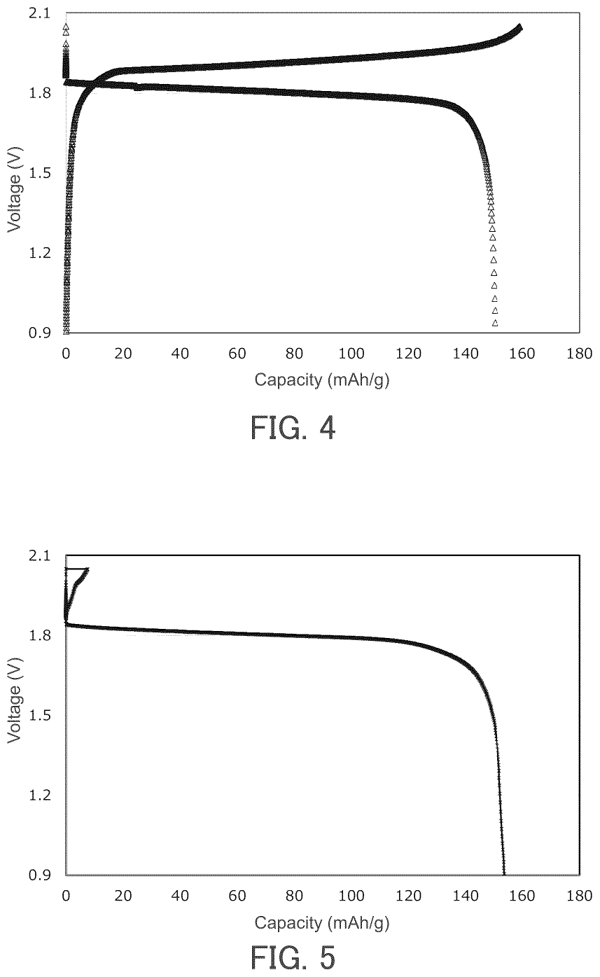

FIG. 4 is a graph showing the initial charge and discharge characteristics of the battery according to Example 2. FIG. 5 is a graph showing the discharge characteristics of the battery according to Example 2 after being held in a fully charged state for 100 hours in a 125° C. atmosphere. These graphs demonstrate that the battery according to Example 2 has a large plateau and can stably operate even after being held in a 125° C. atmosphere.

The above confirms that it is possible to provide a battery having a large plateau by using lithium iron phosphate (LiFePO₄) as the positive electrode active material and using lithium titanate Li₄Ti₅O₁₂ as the negative electrode active material.

Furthermore, it is possible to provide a battery having a large plateau even by using, instead of lithium iron phosphate (LiFePO₄), a positive electrode active material including a compound, the compound including a transition metal element and an oxoanion and being capable of an electrochemical two-phase coexistence reaction with lithium.

The negative electrode active material is not limited to lithium titanate and may include, for example, a carbon material or alloy-based material capable of occluding and releasing lithium ions.

### INDUSTRIAL APPLICABILITY

The battery of the present disclosure can be suitably used, for example, as a power source for smartphones and other mobile devices, as a driving power source for electric vehicles and other vehicles, as a power source for various in-vehicle devices, and as a storage device for solar energy and other natural energy.

What is claimed is:

1. A battery comprising:
a positive electrode layer;
a negative electrode layer; and
a solid electrolyte layer disposed between the positive electrode layer and the negative electrode layer, wherein
the positive electrode layer includes a positive electrode active material and a first solid electrolyte material,
the negative electrode layer includes a negative electrode active material and a second solid electrolyte material,
the positive electrode active material includes a compound, the compound including a transition metal element and an oxoanion and being capable of an electrochemical two-phase coexistence reaction with lithium,
the first solid electrolyte material includes Li, M1, and X1,
the M1 is at least one selected from the group consisting of metalloid elements and metal elements other than Li, and
the X1 is at least one selected from the group consisting of F, Cl, Br, and I.

2. The battery according to claim 1, wherein
the positive electrode active material includes the compound as a main component.

3. The battery according to claim 1, wherein
the oxoanion includes B, Si, P, or S.

4. The battery according to claim 3, wherein
the oxoanion is BO₃_{³⁻}, SiO₄_{⁴⁻}, PO₄_{³⁻}, P₂O₇_{⁴⁻}, or SO₄_{²⁻}.

5. The battery according to claim 1, wherein
the compound has an olivine structure.

6. The battery according to claim 1, wherein
the transition metal element is at least one selected from the group consisting of Fe, Mn, Ni, and Co.

7. The battery according to claim 1, wherein
the positive electrode active material includes LiFePO₄.

8. The battery according to claim 1, wherein
the M1 includes at least one selected from the group consisting of Na, K, Mg, Ca, Sr, Ba, Sc, Y, Zr, Hf, La, Ce, Pr, Nd, Sm, Eu, Gd, Tb, Dy, Ho, Er, Tm, Yb, and Lu.

9. The battery according to claim 8, wherein
the M1 includes Y.

10. The battery according to claim 9, wherein
the first solid electrolyte material includes at least one selected from the group consisting of Li₃₋₃ₐY₁₊ₐBr₂Cl₄ and Li₃₋₃ₐY₁₊ₐCl₆,
where a satisfies −0.2≤a≤0.2.

11. The battery according to claim 1, wherein
the negative electrode active material includes Li₄Ti₅O₁₂.

12. The battery according to claim 1, wherein
the second solid electrolyte material includes Li, M2, and X2,
the M2 is at least one selected from the group consisting of metalloid elements and metal elements other than Li, and
the X2 is at least one selected from the group consisting of F, Cl, Br, and I.
